(19) United States
(12) Patent Application Publication
(10) Pub. No.: US 2018/0285708 A1
(43) Pub. Date: Oct. 4, 2018

(54) Intelligent Fixture System

(71) Applicant: Walmart Apollo, LLC, Bentonville, AR (US)

(72) Inventor: Starla Christine Morgan, Bentonville, AR (US)

(21) Appl. No.: 15/943,219

(22) Filed: Apr. 2, 2018

Related U.S. Application Data
(60) Provisional application No. 62/480,790, filed on Apr. 3, 2017.

(51) Int. Cl. G06K 19/07; G06Q 10/08; G06K 7/10

(52) U.S. Cl. CPC G06K 19/0723; G06Q 10/087; G06K 2017/0051; G06K 7/10237; G06K 7/10099

(57) ABSTRACT

Exemplary embodiments of the present disclosure are related to an intelligent fixture system in which portable electronic devices and RFID readers communicate with computing systems to implement one or more actions or operations and aggregated RFID tag information transmitted by the RFID readers to the computing systems can be utilized to determine information about tasks being performed by the user of the portable electronic devices. Embodiments of the distributed system can include the portable electronic devices, RFID readers, and a computing system.

### RELATED APPLICATIONS

This application claims priority to U.S. Provisional Application No. 62/480,790 filed on Apr. 3, 2017, the content of which is hereby incorporated by reference in its entirety.

### BACKGROUND

In large environments, it can be difficult to track item information and locations of items. For example, when a user is looking for an item in a facility, but the item it is not positioned in its usual or expected location, it can be difficult for the user to know where the item is or whether the item is even located in the retail establishment.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary intelligent fixture system in accordance with embodiments of the present disclosure.

FIG. 2A-C show exemplary intelligent fixtures in accordance with embodiments of the present disclosure.

FIG. 3 is an exemplary computing device for implementing embodiments of the present disclosure.

FIG. 4 is a block diagram of an exemplary a distributed environment for implementing an intelligent fixture system in accordance with embodiments of the present disclosure.

FIGS. 5-6 show a flowchart illustrating a process implemented by an exemplary intelligent fixture system in accordance with embodiments of the present disclosure.

### DETAILED DESCRIPTION

Exemplary embodiments of the present disclosure are related to an intelligent fixture system. Portable electronic devices and RFID readers associated with fixtures can communicate with computing systems to implement one or more actions or operations in embodiments of the intelligent fixture system. The system can aggregate RFID tag information transmitted by the RFID readers to the computing systems, and the RFID tag information can be utilized to determine information about locations of physical objects and/or tasks being performed by the users of the portable electronic devices.

Exemplary embodiments of the intelligent fixture system can include RFID readers, fixtures distributed throughout a geographic area, and a computing system in communication with the RFID readers. Each one of the RFID readers has at least one antenna. Each of the fixtures is assigned at least one of the RFID readers and includes at least one label affixed thereto. RFID tags can be affixed to physical objects disposed on the fixtures. Each physical object can have at least one RFID tag affixed thereto.

The computing system can be configured to receive, from a first mobile device, an image scanned by the first mobile device of a first label affixed to a first one of the fixtures and a request for a first one of the physical objects indicated by the first label, extract an object identifier from the image, and autonomously control the RFID readers to search for a first set of the RFID tags corresponding to the object identifier in response to obtaining the object identifier. The computing system can aggregate RFID tag information received from the RFID readers to generate the first set of RFID tags, estimate a location of each of the RFID tags in the first set based on a first set of the RFID readers that read at least one of the RFID tags and a corresponding first set of the fixtures assigned to the first set of the RFID readers, and transmit the location of each of the RFID tags in the first set to the first mobile device or a second mobile device to activate location tracking of the RFID tags in the first set of RFID tags on the first mobile device or the second mobile device.

In accordance with embodiments of the present disclosure, the computing system can be further configured to calculate a total quantity of the physical objects indicated by the first label based on each of the RFID tags in the first set. In response to determining that the total quantity of the physical objects being lower than a first specified value, the computing system can be configured to calculate the quantity of the physical objects indicated by the first label and not affixed with the first set of RFID tags. In response to the quantity of the physical objects indicated by the first label and not affixed with the first set of RFID tags being higher than a second specified value, the computing system can be configured to transmit a first alert to the first mobile device or the second mobile device to indicate the quantity of the physical objects indicated by the first label and not affixed with the first set of RFID tags. In response to the quantity of the physical objects indicated by the first label and not affixed with the first set of RFID tags being lower than a second specified value, the computing system can be configured to transmit a second alert to the second mobile device to activate a specified process.

Embodiments of the fixtures can include intelligent shelves, intelligent bins, and/or intelligent carts. The fixtures can include one or more sensors for sensing one or more properties of physical objects disposed on or in the fixtures.

Embodiments of the computing system can be configured to calculate a quantity of the physical objects indicated by the first label and located on or in each of the fixtures. The location of each of the RFID tags can indicate at which of the fixtures the physical objects are located.

In accordance with embodiments of the present disclosure, an exemplary method implemented in an intelligent fixture system is provided. The intelligent fixture system includes fixtures distributed throughout a geographic area. Each of the fixtures includes at least one label affixed thereto and is assigned at least one RFID reader. Each one of the plurality of RFID readers has at least one antenna. The fixtures include intelligent shelves, intelligent bins, and intelligent carts, each of which includes one or more sensors for sensing one or more properties of each different physical object. The method includes receiving, from a first mobile device, an image scanned by the first mobile device of a first label affixed to a first one of fixtures and a request for a first one of physical objects indicated by the first label, and extracting an object identifier from the image; autonomously controlling the RFID readers to search for a first set of RFID tags corresponding to the object identifier. Each one of the RFID tags is affixed to a different physical object disposed on the fixtures. The method also includes aggregating RFID tag information received from the RFID readers to generate the first set of RFID tags, estimating a location of each of the RFID tags in the first set based on a first set of the RFID readers that read at least one of the RFID tags and a corresponding first set of the fixtures assigned to the first set of the RFID readers, and transmitting the location of each of the RFID tags in the first set to the first mobile device or a second mobile device to activate location tracking of the RFID tags in the first set of RFID tags on the first mobile device or the second mobile device. The location of each of the RFID tags indicates at which of the fixtures the first one of the physical objects is located. In accordance with embodiments of the present disclosure, an exemplary non-transitory computer-readable medium storing instructions that are executable by a processing device is provided, and execution of the instructions by the processing device causes the processing device to perform the method.

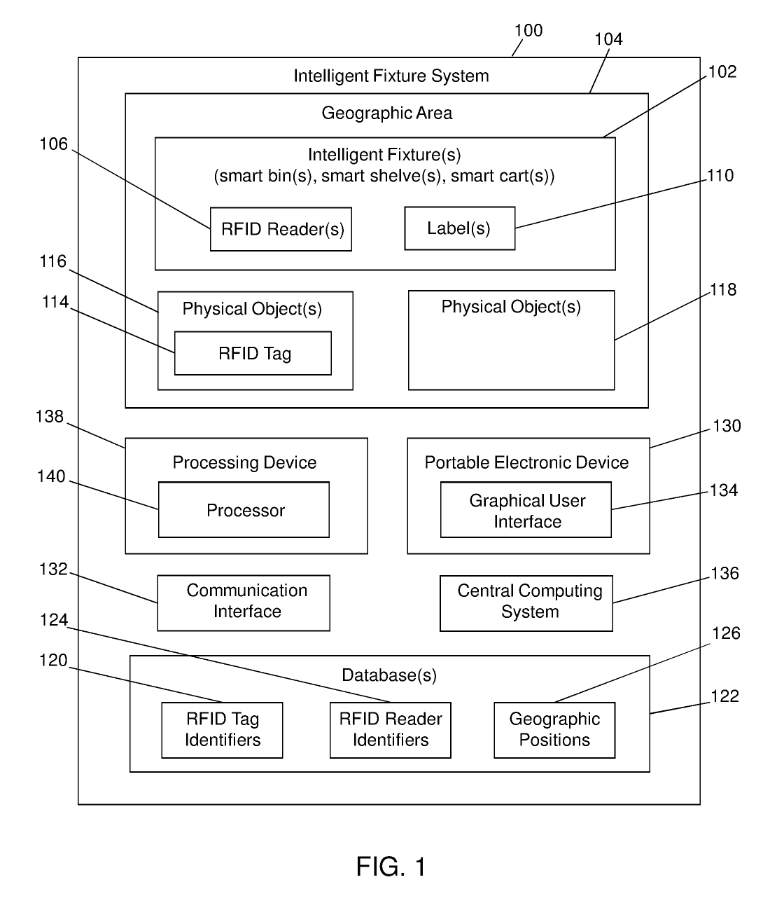

FIG. 1 is a block diagram of an exemplary intelligent fixture system 100 (hereinafter “system 100”) of the present disclosure. The system 100 generally includes one or more intelligent fixtures 102 disposed within a geographic area 104. The geographic area 104 can include aisles, zones, or departments for different categories or types of physical objects.

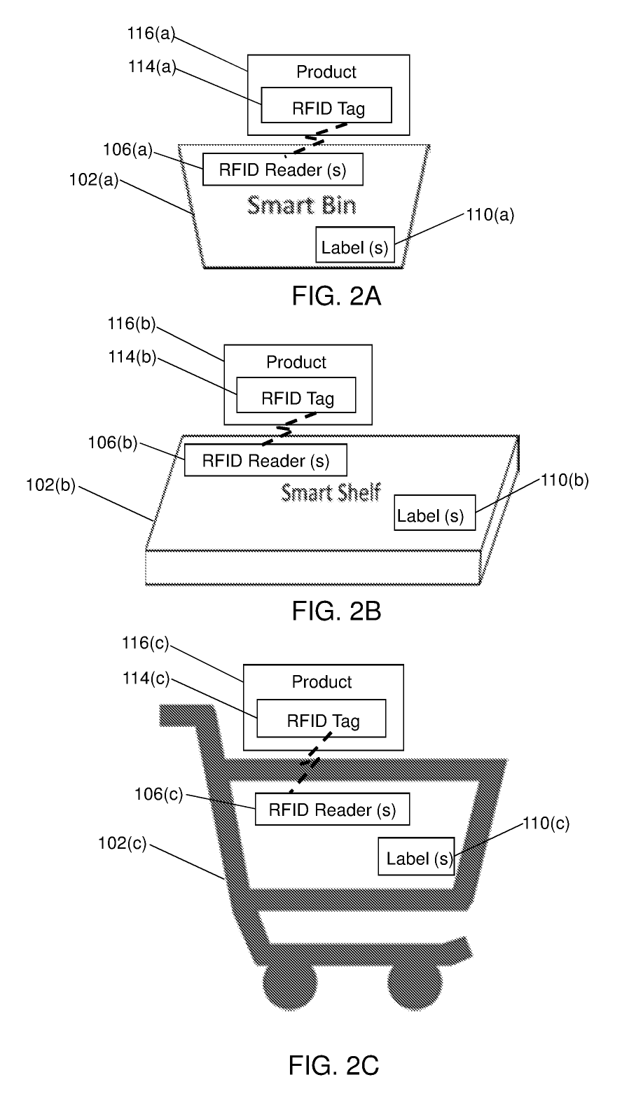

The intelligent fixtures 102 may be any kind of containers used for storing or holding physical objects 116. For example, the intelligent fixtures 102 can include smart bins, smart shelves, smart carts, or a combination thereof, each of which are described in more detail below in FIGS. 2A-C. The intelligent fixtures 102 can include one or more labels 110 affixed thereon, mounted thereon, or other associated with the intelligent fixtures 102. Each of the labels 110 can include information corresponding to specific instances of a physical object that is assigned to be located on the intelligent fixtures 102.

The system 100 generally includes one or more portable electronic devices 130. In one embodiment, when a user in the geographic area 104 wants a specific physical object, the user finds the intelligent fixture 102 in the geographic area 104 that is affixed with the label 110 indicating that the specific physical object is assigned to this intelligent fixture 102. If no instances of the specific physical object are positioned at the intelligent fixture 102, the user can use the portable electronic device 130 to capture an image of the label 110 by scanning or taking a picture of the label 110. In response to capturing the image of the label, the portable electronic device can send the captured image to a central computing system 136. After receiving the captured image of the label 110, the central computing system 136 can activate one or more radio-frequency identification (RFID) readers 106.

As shown in FIG. 1, each intelligent fixture 102 is associated with at least one of the one or more radio-frequency identification (RFID) readers 106. The RFID readers 106 can be configured to read RFID tags 114 within range of the RFID readers. When an RFID tag is within the range of an RFID reader, the RFID tag can receive a radio-frequency (RF) signal from the RFID reader and the RFID tags can respond with a radio-frequency (RF) signal. The RF response signal from the RFID tag can include a unique identifier associated with the RFID tag and/or data stored in memory of the RFID tag. For example, in exemplary embodiments, the RFID tags can be affixed to the physical objects 116, and the RF response signal from each of the RFID tags 114 can include a unique identifier 120 and data associated with the physical object to which the RFID tag is affixed. The unique identifier 120 can be, for example, an alphanumeric string, that allows the computing system 136 to differentiate between the RFID tags 114 and the physical objects to which the RFID tags are affixed. The unique identifiers 120 can be electronically stored in one or more databases 122 of the system 100. Each RFID reader 106 can also have a unique identifier 124 (e.g., an alphanumeric value or string) to allow for differentiation between the RFID readers 106 within the geographic area 104 and for identification of the geographic position of each RFID reader 106 within the geographic area 104. The RFID reader identifiers 124 can be electronically stored in one or more databases 122 of the system 100.

The RF signal response transmitted from the RFID tags 114 and/or the RF signal transmitted from the RFID readers 106 to the RFID tags 114 can be used to identify geographic positions 126 of the physical objects 116 within the geographic area 104. The geographic positions 126 can include information regarding the type of department, the aisle, and the fixture related to the location of the physical objects 116. The geographic positions 126 can be stored in the database 122.

FIGS. 2A-C show exemplary intelligent fixtures of the present disclosure. As described above, a smart bin 102(a) shown in FIG. 2A, a smart shelf 102(b) shown in FIG. 2B, and a smart cart 102(c) shown in FIG. 2C are examples embodiments of the intelligent fixtures 102. Referring to FIG. 2A, one or more labels 110(a) are mounted on the smart bin 102(a). Each of the label 110(a) includes object information of one kind of physical objects 116(a) that is assigned to be positioned in the smart bin 102(a). In some embodiments, the smart bin 102(a) may not have any labels that are associated with physical objects assigned to be positioned in the smart bin 102(a). Instead, any physical object can be arbitrarily or otherwise placed in the smart cart 102(c). One or more (RFID) readers 106(a) are associated with the smart bin 102(a). Each of the physical objects 116(a) are affixed with a RFID tag 114(a). The RFID reader 106(a) can be activated to receive a RF signal transmitted from the RFID tags 114(a).

Similarly, referring to FIG. 2B, the smart shelf 102(b) is affixed with one or more labels 110(b) that indicate the object information of each physical object 116(b) which is assigned to be positioned on the smart shelf 102(b). One or more (RFID) readers 106(b) are associated with the smart shelf 102(b), and can be activated to receive a RF signal transmitted from the RFID tags 114(b) affixed to each physical object 116(b). As another example, referring to FIG. 2C, the smart cart 102(c) can be affixed with one or more labels 110(c) that indicate the object information of each physical object 116(c) which is assigned to be positioned in the smart cart 102(c). In some embodiments, the smart cart 102(c) may not have any labels that are associated with physical objects assigned to be positioned in the smart cart 102(c). Instead, any physical object can be arbitrarily or otherwise placed in the smart cart 102(c). One or more (RFID) readers 106(c) are associated with the smart cart 102(c), and can be activated to receive a RF signal transmitted from the RFID tags 114(c) affixed to each physical object 116(c).

Referring back to FIG. 1, upon identification of the geographic position 126 of a specific physical object 116, the geographic position 126 and the unique RFID tag identifier 120 associated with the physical object 116 is electronically transmitted to a portable electronic device 130 of the user via a communication interface 132.

In one embodiment, the portable electronic device 130 can include a graphical user interface (GUI) 134 for receiving the geographic position 126 and activating location tracking on the portable electronic device 130 in response to receipt of the geographic position 126. Alternatively, a graphical user interface (GUI) 134 can also receive a notification indicating that someone will bring the desired physical object to the user. In some embodiments, the portable electronic device 130 can be specific to associate user who can assist with questions relating to physical objects located in a department corresponding to the geographic position 126 of the physical object 116. The portable electronic device 130 can include a graphical user interface (GUI) 134 for receiving the assistance request from another user. If two or more portable electronic devices 130 receive the transmitted request for assistance, the first user capable of providing assistance can indicate via the GUI 134 that assistance will be provided by he/she, thereby preventing multiple users responding to a single request.

As shown in FIG. 1, the system 100 includes the central computing system 136, which is in communication with the RFID readers 106 via the communication interface 132. The RFID readers 106 can be configured to transmit signals to the central computing system 136 and, based on the signals received from the RFID readers 106, the central computing system 136 can be configured to transmit an electronic message to one or more portable electronic devices 130 in the geographic area 104 including the estimated location of product specific physical object 116 corresponding to the scanned image of the label (e.g., the geographic position 126). In some embodiments, triangulation based on multiple RFID readers 106 receiving the RF response signal from the RFID tag 114 corresponding to the specific physical object can be used to estimate the geographic position of the specific physical object 116 at the geographic position 126. For example, signal strength of the RF response signal received by each of the RFID readers 106 can be different based on the distance between the antennas of the RFID readers and the RFID tag 114. The different signal strengths of the of the RF response signal received by the RFID readers 106 can be used to estimate the geographic position 126. In some embodiments, the system 100 can include a processing device 138 including a processor 140 configured to operate in cooperation with the central computing system 136, the portable electronic device 130, and/or the communication interface 132 to determine and transmit the position of the physical object 116 within the geographic area 104.

In one embodiment, the system 100 further includes physical objects 118 that are not affixed with the RFID tags. For example, when the physical objects are returned to the geographic area 104, the returned physical objects may not have RFID tags. The central computing system 136 can be configured to calculate the quantity of the physical objects 118 and transmit the corresponding information to the portable electronic device 130 operated by the user.

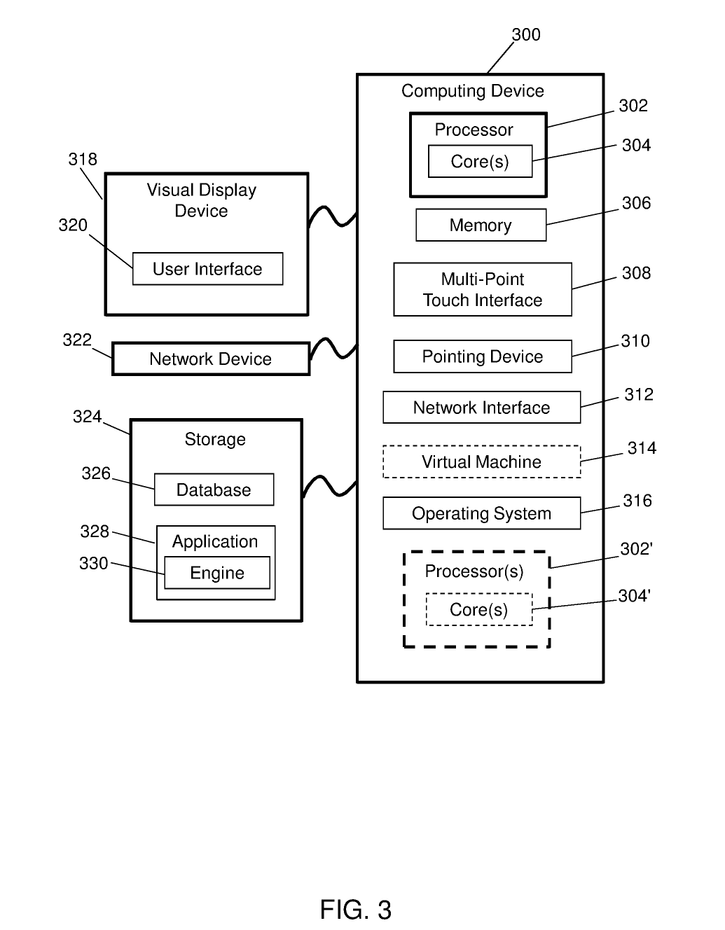

FIG. 3 is a block diagram of a computing device 300 in accordance with exemplary embodiments of the present disclosure. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 306 included in the computing device 300 may store computer-readable and computer-executable instructions or software (e.g., applications 328, such as user tracking and communication engines 330) for implementing exemplary embodiments of the present disclosure (e.g., instructions for operating the RFID tag 114, instructions for operating the RFID reader 106, instructions for operating the processing device 138, instructions for operating the portable electronic device 130, instructions for operating the communication interface 132, instructions for operating the central computing system 136, combinations thereof, or the like). The computing device 300 also includes configurable and/or programmable processor 302 and associated core 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device 300 may be shared dynamically. A virtual machine 314 may be provided to handle a process running on multiple processors so that the process appears to be using only one computing resource rather than multiple computing resources. Multiple virtual machines may also be used with one processor. Memory 306 may include a computer system memory or random access memory, such as DRAM, SRAM, EDO RAM, and the like. Memory 306 may include other types of memory as well, or combinations thereof.

A user may interact with the computing device 300 through a visual display device 318 (e.g., a personal computer, a mobile smart device, or the like), such as a computer monitor, which may display one or more user interfaces 320 (e.g., GUI 134) that may be provided in accordance with exemplary embodiments. The computing device 300 may include other I/O devices for receiving input from a user, for example, a keyboard or any suitable multi-point touch interface 308, a pointing device 310 (e.g., a mouse). The keyboard 308 and the pointing device 310 may be coupled to the visual display device 318. The computing device 300 may include other suitable conventional I/O peripherals.

The computing device 300 may also include one or more storage devices 324, such as a hard-drive, CD-ROM, or other computer readable media, for storing data and computer-readable instructions and/or software that implement exemplary embodiments of the system 100 described herein. Exemplary storage device 324 may also store one or more databases 326 for storing any suitable information required to implement exemplary embodiments. For example, exemplary storage device 324 can store one or more databases 326 for storing information, such as data relating to RFID tag identifiers 120, RFID reader identifiers 124, the geographic position 126, combinations thereof, or the like, and computer-readable instructions and/or software that implement exemplary embodiments described herein. The databases 326 may be updated by manually or automatically at any suitable time to add, delete, and/or update one or more items in the databases.

The computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 312 may include a built-in network adapter, network interface card, PCMCIA network card, card bus network adapter, wireless network adapter, USB network adapter, modem or any other device suitable for interfacing the computing device 300 to any type of network capable of communication and performing the operations described herein. Moreover, the computing device 300 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 300 may run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 316 may be run in native mode or emulated mode. In an exemplary embodiment, the operating system 316 may be run on one or more cloud machine instances.

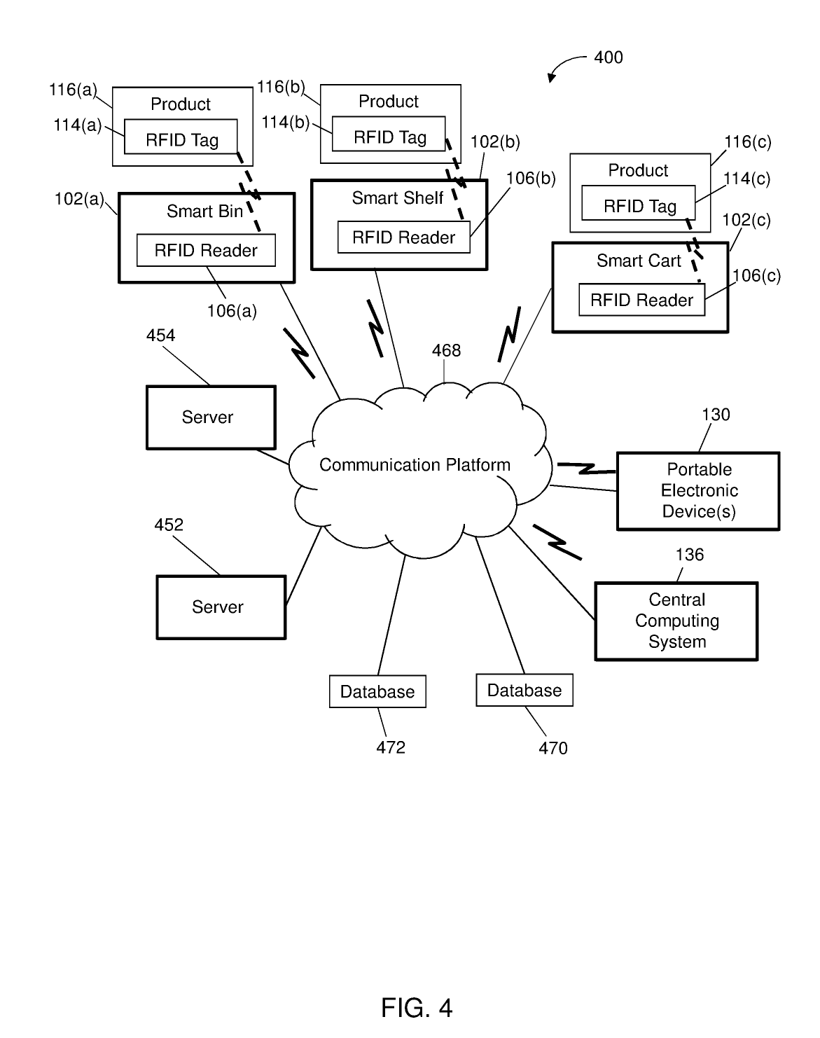

FIG. 4 is a block diagram of an exemplary low stock notification system environment 400 in accordance with exemplary embodiments of the present disclosure. The environment 400 can include servers 452, 454 configured to be in communication with intelligent fixtures, i.e., smart bins 102(a) including RFID readers 106(a), smart shelves 102(b) including RFID readers 106(b), and smart carts 102(c) including RFID readers 106(c), and physical objects 116(a) including RFID tags 114(a), physical objects 116(b) including RFID tags 114(b), and physical objects 116(c) including RFID tags 114(c), via a communication platform 468, which can be any network over which information can be transmitted between devices communicatively coupled to the network. For example, the communication platform 468 can be the Internet, Intranet, virtual private network (VPN), wide area network (WAN), local area network (LAN), and the like. In some embodiments, the communication platform 468 can be part of a cloud environment. The environment 400 can include portable electronic devices 130 and central computing systems 136, which can be in communication with the servers 452, 454, as well as the intelligent fixtures 102(a), 102(b), 102(c), and the physical objects 116(a) and 116(b), via the communication platform 468. The environment 400 can include repositories or databases 470, 472, which can be in communication with the servers 452, 454, as well as the intelligent fixtures 102(a), 102(b), 102(c), and the physical objects 116(a), 116(b), and 116(c), the portable electronic devices 130 and the central computing systems 136, via the communications platform 468.

In exemplary embodiments, the servers 452, 454, smart bins 102(a), smart shelves 102(b), and smart carts 102(c), physical objects 116(a), 116(b), 116(c), portable electronic devices 130, central computing systems 136, and databases 470, 472 can be implemented as computing devices (e.g., computing device 300). Those skilled in the art will recognize that the databases 470, 472 can be incorporated into one or more of the servers 452, 454 such that one or more of the servers 452, 454 can include databases 470, 472. In some embodiments, the database 470 can store the RFID tag identifiers 120 and the RFID reader identifiers 124, and the database 472 can store the geographic positions 126. In some embodiments, a single database 470, 472 can store the RFID tag identifiers 120, the RFID reader identifiers 124, and the geographic positions 126.

In accordance with embodiments of the present disclosure, the intelligent fixture system within the retail establishment may inform associates about where product is located in store at a particular time. For example, when the user is in the aisle needing a product that appears out of stock but is available in the store for purchase. The user can scan the shelf label and the system is informed that the user is looking for the item. The RFID readers associated with the fixture can inform the system that requested product is not on the shelf. Then the system is triggered to scan the other intelligent fixtures in the store for the product. Based on the received RFID tag information, the system knows that the inventory information of the requested products. The system can then report back to the user where to find the item (for example, one of the requested products is setting on the shelf one aisle over). Further, the system can report to Customer Service or a Sales Floor associate that the product is being sought after, in stock, but out of its assigned location. They can assist the user in getting to the product and/or make sure to get it stocked properly. Therefore, store associates could be better equipped to react to get the right product to users in a more timely manner.

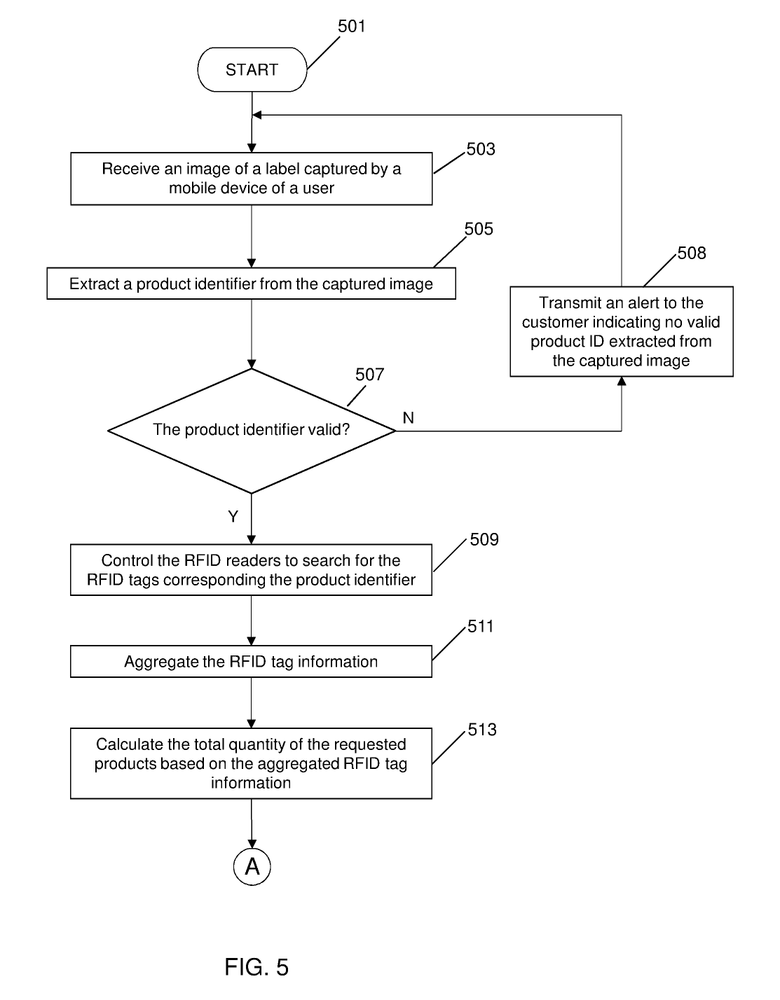

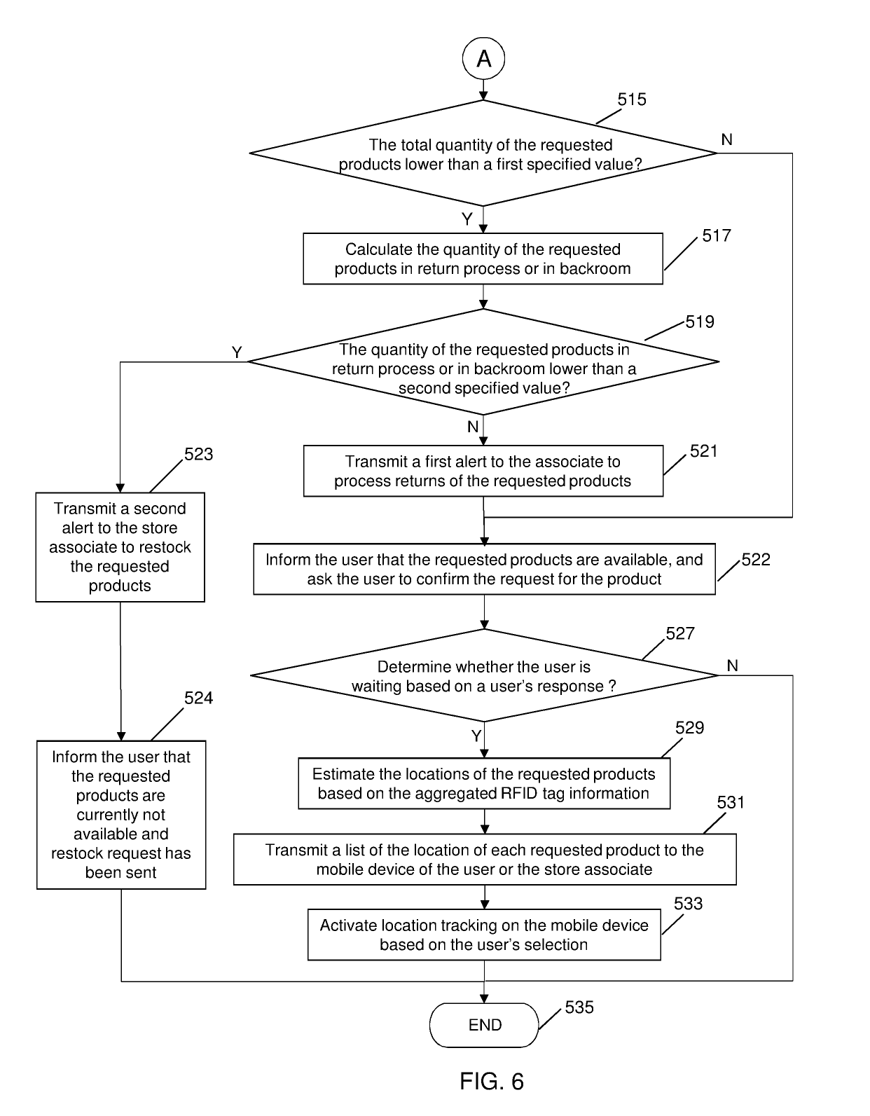

FIGS. 5-6 shows a flowchart illustrating a process implemented by an exemplary low stock notification system for responding to requests for physical objects by customs in accordance with embodiments of the present disclosure. The process starts from step 501. When a user cannot find the desired physical object, the user scans or take a picture of the label attached on the intelligent fixture using a mobile device. The label includes information identifying which physical objects are assigned to this intelligent fixture. At step 503, the system receives the captured image transmitted from the mobile device. At step 505, the physical object ID of the requested physical object can be extracted based on the captured image of the label.

At step 507, the system determines whether the extracted physical object ID is a valid physical object ID in the retail establishment, i.e., determines whether the requested physical object is sold in the retail establishment. If not, at step 508 the system will transmit an alert to the user indicating that the captured image does not include a valid physical object ID, and the process go back to step 503 such that the user can capture another images of the labels.

If the extracted physical object ID is determined as a valid physical object ID at step 507, the system can be triggered to autonomously control each RFID reader associated with the intelligent fixture to search for the requested physical object in response to obtaining the extracted valid physical object ID at step 509, and when the requested physical objects are found, the RFID tag information, which includes the geographic positions of the found physical object, can be received by the RFID readers. Then at step 511, the system aggregates all the RFID tag information received by the RFID readers. For example, the aggregated information can indicate that there are X quantity of the requested physical objects located in the smart bins not found by the users; Y quantity of the requested physical objects located in the smart carts currently pushed by users across the retail establishment; Z quantity of requested physical objects positioned on the smart shelves with labels of other physical objects. Accordingly, at step 511, all the above RFID tag information are aggregated, and at step 513 the total quantity of the requested physical objects is calculated based on the aggregated RFID tag information.

Then at step 515, the system determines whether the total quantity of the requested physical objects is lower than a first specified value, i.e., whether the shelf inventory of the requested physical object is out of stock or below a low stock level. If yes, at step 517, the system further calculate the quantity of the requested physical objects that are in return process or in backroom, i.e., calculate the quantity of the requested physical objects that are not affixed with the RFID tags. Then at step 519, it is determined whether the quantity of the requested physical objects in return process or in backroom is lower than a second specified value, i.e., whether there is any requested physical object in return process or in backroom, or whether the quantity of the requested physical object is lower than the low stock level. If yes, then at step 523, a system alert will be transmitted to the associates' portable electronic devices to request for restocking the requested physical objects. When two or more store associates receive the restock alert, the first associate capable of active the restock process can indicate via the GUI that he/she will handle the restock, thereby preventing multiple associates responding to a single alert. Then at step 524, the user will be informed that the requested physical objects are currently not available and restock request has been sent. Then the process ends at step 535.

Alternatively, at step 524, in addition to informing the user that the requested physical objects are currently not available and restock request has been sent, the system can also send a list of one or more substitute physical objects for the requested physical objects. The one or more substitute physical objects can be the most popular physical objects selected by the user when the required physical objects are not available. In response to selection by the user, the system can further make a performance analysis comparing the originally requested physical object and the substitute physical objects selected by the user. If the substitute outperforms the originally requested physical object, the substitute could not only temporarily be placed on the shelf to fill the out of stock, but also be considered for permanent placement on the planogram, or even replacement of the originally requested physical object. In addition, in response to selection of a substitute object, the system can trigger the RFID readers to read the tags of physical objects to search for the selected substitute physical objects. Upon locating the selected substitute physical object in the facility, the system can notify the user of the location of the selected substitute physical object and can activate location tracking of the selected substitute physical on the user's device (e.g., the user's mobile device).

Referring back to step 519, when it is determined whether the quantity of the requested physical objects in return process or in backroom is not lower than a second specified value, i.e., whether there is one or more requested physical objects in return process or in backroom, at step 521, a system alert will be transmitted to the store associates requesting the associates to process the returns or obtain the requested physical objects from the backroom. Then at step 522, the system can inform the user that the requested physical objects are available, and ask the user to confirm the request for the physical object.

Now referring back to step 515, when the system determines whether the total quantity of the requested physical objects is not lower than a first specified value, i.e., whether the shelf inventory of the requested physical object is higher than the low stock level, the process goes to step 522 where the system can inform the user that the requested physical objects are available, and ask the user to confirm the request for the physical object.

After receiving the notification at step 522, the user can response whether he/she still need the requested physical objects. At step 527, based on the user's response, the system determines whether the user is still waiting for the physical objects. If the user do not need the physical objects anymore, or the user does not response in a specific time period, the process will end at step 535. If the user is still waiting, at step 529 the system can estimate the location of each requested physical object found by the RFID readers based on the aggregated RFID tag information. At step 531, a list of locations of each requested physical objects can be transmitted to the mobile device of the user and the store associates.

At step 533, after receiving the list of the requested physical objects, the user can select one or more of the requested physical objects according to the location information, and the location tracking function on the mobile device can be activated, in response to the user's selection, to assist the user to locate the selected physical objects. Alternatively, if the user requests the store associates to bring over the physical objects, the location tracking function on the mobile device of the associate can be activated, in response to the user's request, to assist the associates to locate the selected physical object. Thus, the process 500 ends at step 535.

In another embodiment, the store associates may also receive location information of the user, which may be obtained based on the signal transmitted from the mobile device operated by the user. Accordingly, when two or more store associates receive the list of physical object locations, the first associate capable of providing assistance, or the associate whose location is closest to the user's location, can indicate via the GUI that assistance will be provided by he/she, thereby preventing multiple associates responding to a single request.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. An intelligent fixture system comprising:
a plurality of RFID readers, each one of the plurality of RFID readers having at least one antenna;
a plurality of fixtures distributed throughout a geographic area, each of the plurality of fixtures being assigned at least one of the RFID readers and including at least one label affixed thereto;
a plurality of RFID tags, each one of the RFID tags being affixed to a different physical object disposed on the plurality of fixtures;
a computing system in communication with the plurality of RFID readers, the computing system configured to:
receive, from a first mobile device, an image scanned by the first mobile device of a first label affixed to a first one of the plurality of fixtures and a request for a first one of the physical objects indicated by the first label;
extract an object identifier from the image;
autonomously control the plurality of RFID readers to search for a first set of the plurality of RFID tags corresponding to the object identifier in response to obtaining the object identifier;
aggregate RFID tag information received from the plurality of RFID readers to generate the first set of RFID tags;
estimate a location of each of the RFID tags in the first set based on a first set of the plurality of RFID readers that read at least one of the RFID tags and a corresponding first set of the plurality of fixtures assigned to the first set of the plurality of RFID readers; and
transmit the location of each of the RFID tags in the first set to the first mobile device or a second mobile device to activate location tracking of the RFID tags in the first set of RFID tags on the first mobile device or the second mobile device.

2. The intelligent fixture system of claim 1, wherein the computing system is further configured to calculate a total quantity of the physical objects indicated by the first label based on each of the RFID tags in the first set.

3. The intelligent fixture system of claim 2, wherein, in response to determining that the total quantity of the physical objects being lower than a first specified value, the computing system is configured to calculate the quantity of the physical objects indicated by the first label and not affixed with the first set of RFID tags.

4. The intelligent fixture system of claim 3, wherein, in response to the quantity of the physical objects indicated by the first label and not affixed with the first set of RFID tags being higher than a second specified value, the computing system is configured to transmit a first alert to the first mobile device or the second mobile device to indicate the quantity of the physical objects indicated by the first label and not affixed with the first set of RFID tags, and
in response to the quantity of the physical objects indicated by the first label and not affixed with the first set of RFID tags being lower than a second specified value, the computing system is configured to transmit a second alert to the second mobile device to activate a specified process.

5. The intelligent fixture system of claim 1, wherein the plurality of fixtures include intelligent shelves, intelligent bins, and intelligent carts, each including one or more sensors for sensing one or more properties of each different physical object.

6. The intelligent fixture system of claim 1, wherein the computing system is configured to calculate a quantity of the physical objects indicated by the first label and located in each of the plurality of fixtures.

7. The intelligent fixture system of claim 1, wherein the location of each of the RFID tags indicates at which of the plurality of fixtures the first one of the physical objects is located.

8. A method implemented in an intelligent fixture system including a plurality of fixtures distributed throughout a geographic area, each of the plurality of fixtures including at least one label affixed thereto and being assigned at least one of a plurality of RFID readers, the method comprising:
receiving, from a first mobile device, an image scanned by the first mobile device of a first label affixed to a first one of a plurality of fixtures and a request for a first one of a plurality of physical objects indicated by the first label;
extracting an object identifier from the image;
autonomously controlling the plurality of RFID readers to search for a first set of a plurality of RFID tags corresponding to the object identifier, each one of the RFID tags being affixed to a different physical object disposed on the plurality of fixtures;
aggregating RFID tag information received from the plurality of RFID readers to generate the first set of RFID tags;
estimating a location of each of the RFID tags in the first set based on a first set of the plurality of RFID readers that read at least one of the RFID tags and a corresponding first set of the plurality of fixtures assigned to the first set of the plurality of RFID readers; and
transmitting the location of each of the RFID tags in the first set to the first mobile device or a second mobile device to activate location tracking of the RFID tags in the first set of RFID tags on the first mobile device or the second mobile device.

9. The method of claim 8, further comprising:
calculating a total quantity of the physical objects indicated by the first label based on each of the RFID tags in the first set.

10. The method of claim 9, further comprising:
in response to determining that the total quantity of the physical objects being lower than a first specified value, calculating the quantity of the physical objects indicated by the first label and not affixed with the first set of RFID tags.

11. The method of claim 10, further comprising:
in response to the quantity of the physical objects indicated by the first label and not affixed with the first set of RFID tags being higher than a second specified value, transmitting a first alert to the first mobile device or the second mobile device to indicate the quantity of the physical objects indicated by the first label and not affixed with the first set of RFID tags, and
in response to the quantity of the physical objects indicated by the first label and not affixed with the first set of RFID tags being lower than a second specified value, transmitting a second alert to the second mobile device to activate a specified process.

12. The method of claim 8, wherein the plurality of fixtures include intelligent shelves, intelligent bins, and intelligent carts, each including one or more sensors for sensing one or more properties of each different physical object.

13. The method of claim 8, further comprising:
calculating a quantity of the physical objects indicated by the first label and located in each of the plurality of fixtures.

14. The method of claim 8, wherein the location of each of the RFID tags indicates at which of the plurality of fixtures the first one of the physical objects is located.

15. The method of claim 8, wherein each one of the plurality of RFID readers has at least one antenna.

16. A non-transitory computer-readable medium storing instructions that are executable by a processing device, wherein execution of the instructions by the processing device causes the processing device to:
receive, from a first mobile device, an image scanned by the first mobile device of a first label affixed to a first one of a plurality of fixtures and a request for a first one of a plurality of physical objects indicated by the first label, the plurality of fixtures being distributed throughout a geographic area, and each of the plurality of fixtures being assigned at least one of a plurality of RFID readers and including at least one label affixed thereto;
extract an object identifier from the image;
autonomously controlling the plurality of RFID readers to search for a first set of a plurality of RFID tags corresponding to the object identifier, each one of the RFID tags being affixed to a different physical object disposed on the plurality of fixtures;
aggregate RFID tag information received from the plurality of RFID readers to generate the first set of RFID tags;
estimate a location of each of the RFID tags in the first set based on a first set of the plurality of RFID readers that read at least one of the RFID tags and a corresponding first set of the plurality of fixtures assigned to the first set of the plurality of RFID readers; and
transmit the location of each of the RFID tags in the first set to the first mobile device or a second mobile device to activate location tracking of the RFID tags in the first set of RFID tags on the first mobile device or the second mobile device.
